(19) United States
(12) Patent Application Publication
(10) Pub. No.: US 2012/0090449 A1
(43) Pub. Date: Apr. 19, 2012

(54) ACOUSTIC AND ELECTRIC COMBINED STRINGED INSTRUMENT OF VIOLIN GROUP

(75) Inventor: Jae-Won Lee, Gangwon-do (KR)

(73) Assignee: J-won Music Co., Ltd., Wonju-si, Gangwon-do (KR)

(21) Appl. No.: 13/318,508

(22) PCT Filed: Nov. 26, 2010
(86) PCT No.: PCT/KR2010/008465

§ 371 Date: Nov. 2, 2011

(30) Foreign Application Priority Data
Dec. 4, 2009 (KR) 20-2009-0015736
Oct. 27, 2010 (KR) 10-2010-0105311

(51) Int. Cl. G10H 3/18

(52) U.S. Cl. 84/731

(57) ABSTRACT

Disclosed is an acoustic and electric combined stringed instrument of a violin group. The stringed instrument includes a soundboard including upper and lower panels arranged with an interval therebetween and a side panel surrounding the rims of the upper and lower panels, a neck part extending from the soundboard and provided at a distal end thereof with a head, one or more strings secured between the head and the soundboard, and a piezoelectric element to convert vibration and pressure of the strings into electric signals. The piezoelectric element is embedded in the lower panel and secured by a pressure plate, and a sound post is erected on the pressure plate above the piezoelectric element to transmit pressure and vibration from the strings to the pressure plate through a bridge and the upper panel, which enables generation of acoustic sound from the lower panel and amplified sound from the piezoelectric element.

### BACKGROUND OF THE INVENTION

1. Field of the Invention

The present invention relates to stringed instruments of a violin group, and more particularly, to acoustic and electric combined stringed instruments of a violin group in which acoustic sound and electric sound can be realized using a single musical instrument.

2. Description of the Related Art

In general, stringed instruments of a violin group are musical instruments configured to produce sound using strings. The stringed instruments may produce sound by friction between strings and hairs of a bow or by thrumming strings using fingers, etc. As illustrated in FIG. 1, a conventional stringed instrument, which is of a type producing sound by friction between strings and hairs of a bow, includes a soundboard 2 defining a cavity for air resonance, a neck part 4 extending from the soundboard 2, and a head part 12 provided at a distal end of the neck part 4. Strings 6 used to produce sound are secured between the soundboard 2 and the head part 12 while being supported by a bridge 18.

The soundboard 2 consists of an upper panel 2a, a lower panel 2b and a side panel 2c surrounding the rims of the upper and lower panels 2a and 2b. The upper panel 2a is provided with a sound hole or f-shaped hole 8.

In the stringed instrument of a violin group, vibration generated by initial friction between the strings 6 and hairs of a bow is transmitted to the upper panel 2a by way of the bridge 18 and in turn, is transmitted to the side panel 2c and the lower panel 2b in sequence. As the vibration of the soundboard 2 applies vibration energy to air, sound is produced. The resulting sound is emitted to the outside through the sound hole 8 formed in the upper panel 2a.

There are a variety of methods of amplifying sound created by vibration of the stringed instrument of the violin group. Examples of the methods include a method of amplifying sound signals using a microphone provided at the exterior of the stringed instrument and a method of amplifying vibration sensed by a sensor that is attached to a body of the stringed instrument. Amplifying sound signals using the exterior microphone may result in the most natural sound, but has difficulty in obtaining a desired volume of sound because outside noise is added to the sound of the stringed instrument. In addition to the microphone, a variety of accessories may be attached to the stringed instrument in several ways. These accessories as well as the microphone may vary in the natural frequency of the stringed instrument and consequently, in the volume and tone of sound depending on attachment positions and shapes thereof, which also results in significant variation in responsiveness with respect to respective frequency bands.

In most conventional stringed instruments, such as violins or electric violins, the microphone has been installed below the bridge well suited to receive tension and vibration of the strings, so as to efficiently implement electric amplification. However, conventional electric violins have no soundboard and therefore, cannot produce acoustic sound without electric amplification and produce very little sound on their own.

### SUMMARY OF THE INVENTION

Therefore, the present invention has been made in view of the above problems, and it is an object of the present invention to provide a stringed instrument of a violin group, which can not only produce original acoustic sound, but also realize electric amplification of sound signals while maintaining the original sound to the maximum extent possible, using a single musical instrument.

In the present invention, a piezoelectric element is installed within a soundboard of the stringed instrument of the violin group, which enables production of acoustic sound and electrically amplified sound. In this case, an installation location of the piezoelectric element is very important because this may result in variation in the quality, tone, pressure and volume of sound.

Considering some installation examples of the piezoelectric element, firstly, if the piezoelectric element is installed immediately below the bridge in the same manner as in an electric violin, the piezoelectric element may vary the natural frequency of the bridge, which causes the soundboard to fail to amplify the faint sound due to insufficient vibration of the soundboard. Sound resulting from vibration of the bridge and the upper panel of the soundboard has a frequency greater than a medium level and therefore, vibration of the lower panel of the soundboard also results in sound excluding a low frequency, which makes it difficult to obtain abundant harmonics. Secondly, as illustrated in FIG. 2, the piezoelectric element may be installed at an inner surface of the soundboard at a position A or B. However, in this case, since the piezoelectric element has difficulty in correctly detecting pressure (tension of the strings) and vibration, the resulting volume of sound is too low under the same conditions and there is a need for a greater degree of amplification than electric amplification. This may result in excessive noise and undesirable sound due to amplification of unwanted exterior signals.

In accordance with the present invention, the above and other objects can be accomplished by the provision of an acoustic and electric combined stringed instrument of a violin group, including a soundboard including an upper panel and a lower panel arranged with an interval therebetween and a side panel surrounding the rims of the upper and lower panels, a neck part extending from the soundboard, the neck part being provided at a front surface thereof with a finger board and at a distal end thereof with a head, a string secured between a string reel on the head and a string fixture on a side end of the soundboard while being supported by a bridge, wherein a piezoelectric element is provided in the lower panel, so as to convert vibration and pressure of the string into electric signals, and a sound post in the form of a support rod is installed between a lower surface of the upper panel and the piezoelectric element such that resonance generated from the upper panel is transmitted to the piezoelectric element and the lower panel through the sound post.

The piezoelectric element may be embedded in a recess of the lower panel, and a pressure plate may be interposed between the piezoelectric element and the sound post such that vibration transmitted through the sound post is uniformly distributed throughout the piezoelectric element via the pressure plate.

The piezoelectric element may have a rectangular shape and may be oriented such that a long side thereof is perpendicular to the direction of wood grain and annular rings of the lower panel. The pressure plate may be formed of the same material as that of the lower panel and may be attached to have the same direction of wood grain as that of the lower panel.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of a conventional violin;

FIG. 2 is a cross sectional view illustrating an event in which a sensor is installed within the conventional violin;

FIG. 3A is an analytical image with respect to the volume of sound in an event in which a sensor is installed at an inner surface of a soundboard;

FIG. 3B is an analytical image with respect to the volume of sound in an event in which a piezoelectric element is installed below a sound post;

FIG. 4 is a perspective view of an acoustic and electric combined stringed instrument of a violin group according to the present invention;

FIG. 5 is a cross sectional view of FIG. 4;

FIG. 6 is an enlarged cross sectional view of a sound post illustrated in FIG. 5;

FIG. 7 is a view illustrating the configuration of a piezoelectric element used in the present invention;

FIG. 8A is an analytical graphical image, obtained by a spectrum analyzer, of sound that is generated by a general acoustic violin and recorded by a condenser microphone; and

FIG. 8B is an analytical graphical image with respect to the tone and frequency spectrum of acoustic sound produced by the stringed instrument of the violin group according to the present invention, which is not subjected to electric amplification; and

FIG. 8C is an analytical graphical image with respect to the tone and frequency spectrum of sound produced by the stringed instrument of the violin group according to the present invention, which is electrically amplified using a piezoelectric element.

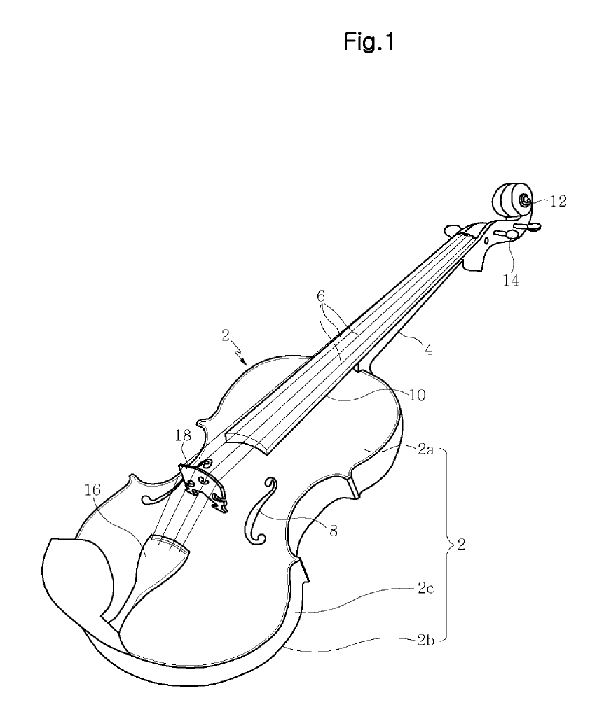

### DETAILED DESCRIPTION OF THE INVENTION

Hereinafter, an exemplary embodiment of the present invention will be described in more detail with reference to the accompanying drawings. In the following description, it is noted that constituent elements of the present invention respectively corresponding to those of the previously described related art are designated by the same reference numerals. Also, in the following description, a stringed instrument of a violin group according to the present invention may simply be referred to as a violin.

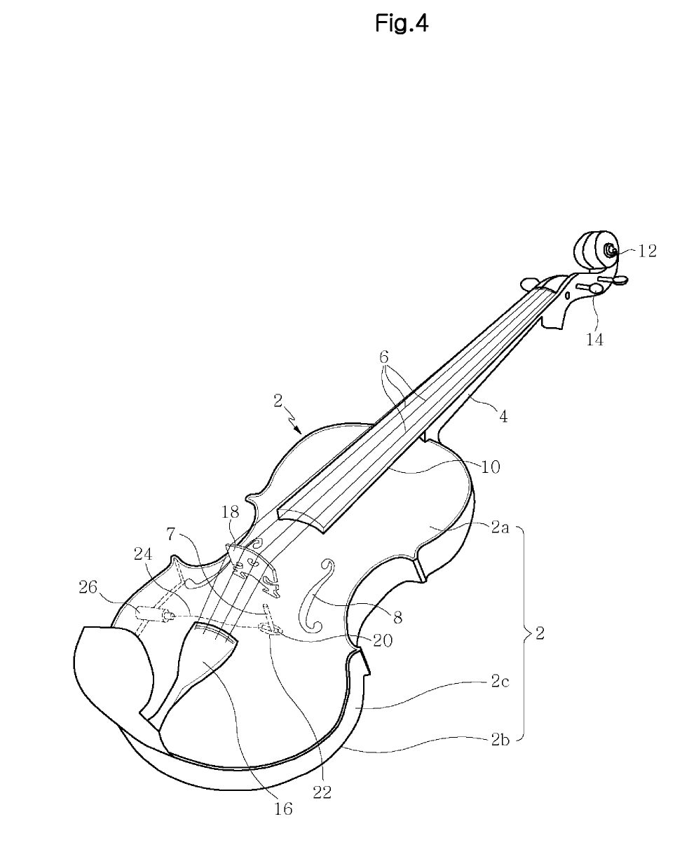

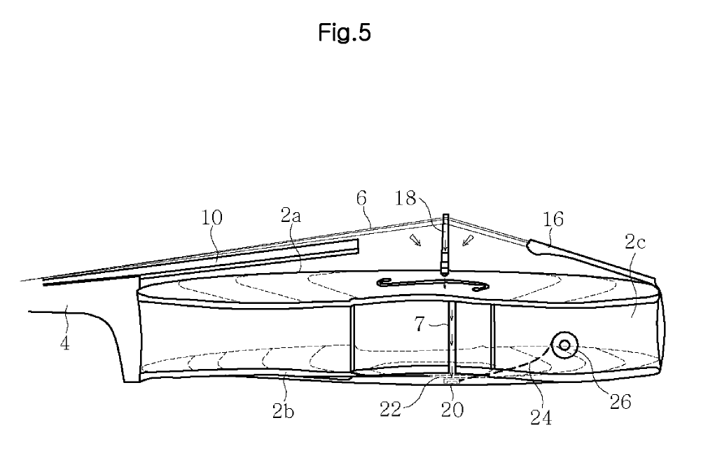

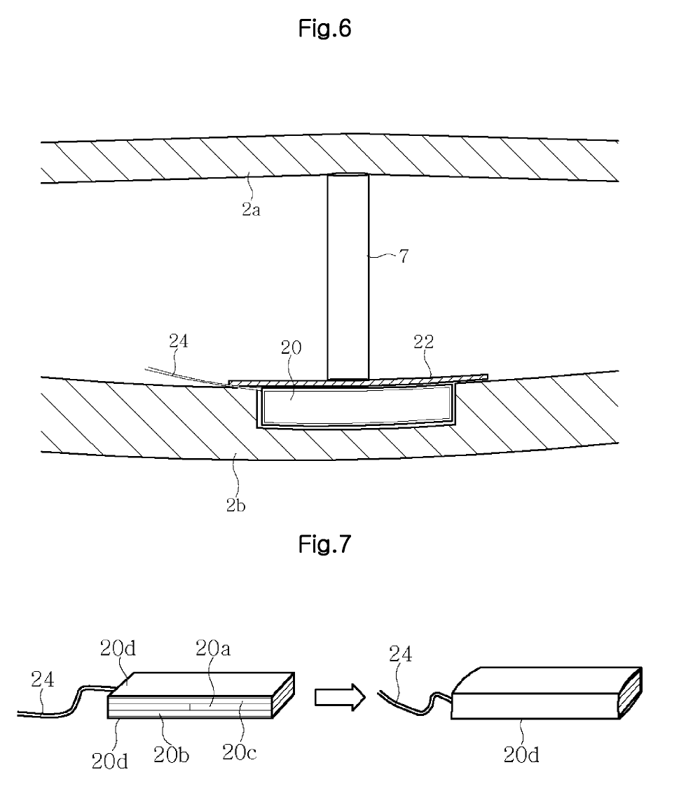

FIG. 4 is a perspective view of a violin according to the present invention, FIG. 5 is a cross sectional view of FIG. 4, FIG. 6 is an enlarged cross sectional view of a sound post illustrated in FIG. 5, and FIG. 7 is a view illustrating the configuration of a piezoelectric element used in the present invention.

As illustrated in FIGS. 4 to 6, the acoustic and electric combined stringed instrument of the violin group according to the present invention includes a soundboard 2 defining a cavity for air resonation, a neck part 4 extending from one side of the soundboard 2, and one or more strings 4 secured between the soundboard 2 and the neck part 4.

The soundboard 2 consists of an upper panel 2a and a lower panel 2b arranged with an interval therebetween, and a side panel 2c surrounding the rims of the upper panel 2a and the lower panel 2b. A sound post 7 in the form of a support rod is installed between a lower surface of the upper panel 2a and the lower panel 2b such that resonance generated from the upper panel 2a is transmitted to the lower panel 2b and a piezoelectric element 20 by way of the sound post 7.

The upper panel 2a is provided at the center thereof with a plurality of symmetrical sound holes 8, so as to transmit air vibration generated within the soundboard 2 to the outside. A finger board 10 is attached to a front surface of the neck part 4 to allow a user to push the strings 6 with his/her fingers. A head 12 is formed at a distal end of the neck part 4. The head 12 is provided with a string reel 14.

The soundboard 2 is provided with a string fixture 16, to which one end of each string 6 can be secured. Each string, one end of which is secured to the string fixture 16, is wound at the other end thereof on the string reel 14 of the head 12 while being supported by a bridge 18. Thereby, the string 6 can be tensioned by adjusting the string reel 14.

As illustrated in FIG. 7, to prepare the piezoelectric element 20 according to the present invention, a copper plate 20c is attached to an upper surface of a thin ceramic plate 20a and a PCB 20b is attached to a lower surface of the thin plate 20a. Thereafter, the copper plate 20c and the PCB 20b are surrounded with a copper tape 20d and a shield electric wire 24 is connected to the PCB 20b. Then, by enclosing the resulting laminate within a rubber housing 20d in order to enhance piezoelectric effects, the piezoelectric element 20 is completed. The piezoelectric element 20 having the above described configuration has a length in a range from 20 to 30 mm and a width in a range from 8 to 14 mm and preferably, has a length in a range from 23 to 27 mm and a width in a range from 10 to 12 mm.

As illustrated in FIG. 6, the piezoelectric element 20 is embedded in a recess defined in the lower panel 2b of the soundboard 2 at a position in contact with a lower end of the sound post 7. Typically, the lower panel 2b of the soundboard 2 has a thickness of 4.6 mm at the center and of 3.8 mm at either side. In the present invention, the piezoelectric element 20 has a thickness of about 2 mm, and the recess, which is formed in the lower panel 2b of the soundboard 2 at a location where the sound post 7 is vertically installed, has a depth of about 2 mm corresponding to the thickness of the piezoelectric element 20 and has a shape suitable to firmly secure the piezoelectric element 20 inserted thereinto. To realize interference-fit without a gap between the piezoelectric element 20 and the recess, the housing 20d of the piezoelectric element 20 is surrounded by an elastic material, such as rubber. Once the piezoelectric element 20 has been fixedly embedded into the recess of the lower panel 2b, a pressure plate 22, which takes the form of a rounded plate having a thickness of 1 to 2 mm, is attached to the piezoelectric element 20 and a peripheral region of the recess of the lower panel 2b with an adhesive (natural material: glue) applied therebetween. The pressure plate 22 is formed of the same material as the lower panel 2b of the soundboard 2, such as highly rigid maple, and is closely and horizontally attached to the lower panel 2b of the soundboard 2 such that the direction of annular rings and wood grain of the pressure plate 22 coincide with that of the lower panel 2b. To ensure more firm attachment, the pressure plate 22 is secured by means of a clamp for 24 hours or more.

The piezoelectric element 20 prepared as described above has a rectangular shape and is oriented such that a long side thereof is perpendicular to the direction of the annular rings and wood grain of the lower panel 2b. In this case, it should be noted that the piezoelectric element is oriented to exhibit an increased vibration amplitude in a direction crossing across the annular rings and wood grain of the lower panel 2b so as to generate a greater volume of sound.

As illustrated in FIG. 6, after the piezoelectric element 20 is embedded in the recess of the lower panel 2b of the soundboard 2, the pressure plate 22 is attached to the piezoelectric element 20 and in turn, the sound post 7 is vertically erected on the pressure plate 22. The attached pressure plate 22 is polished using sandpaper to be as flat as possible in order to ensure easy vertical erection of the sound post 7.

Next, the electric wire 24 is connected to a jack 26 and then, the jack 26 is secured to the side panel 2c. The upper panel 2a of the soundboard 2 is attached to the side panel 2c to which the lower panel 2b has been connected. Then, a head unit, which consists of the finger board 10, the neck part 4 and the head 12, is attached to the soundboard 2. After application of a varnish for coloring, the string fixture 16, a jaw pad and the string reel 14 are mounted at proper positions and then, the strings 6 are installed. The bridge 18 is erected below the strings 6 and the sound post 7 is erected on the pressure plate 22 between the upper panel 2a and the lower panel 2b of the soundboard 2.

The sound post 7 may serve to determine desired sound depending on an installation position thereof because the pressure, quality and tone of sound depend on the position of the sound post 7. For example, sharper sound may be generated as a distance between the sound post 7 and the bridge 18 decreases, whereas smoother sound may be generated as the distance between the sound post 7 and the bridge 18 increases. Additionally, a higher frequency band is obtained as the sound post 7 is located closer to an E string, whereas a lower frequency band is obtained as the sound post is located closer to a G string. This provides the same effects as amplification using an amplifier because the sound post 7 always moves over the pressure plate 22. Moreover, with this configuration, varying sound in different ways is possible when using an equalizer or an effecter, and sound similar to original sound of the stringed instrument to the maximum extent is generated when there is no separate device.

The pressure plate 22 is formed of maple, preferably, well dried hard maple and is oriented such that the direction of wood grain of the pressure plate 22 coincides with that of the soundboard 2. As has been empirically proven, although the piezoelectric element 20 is embedded in the lower panel 2b of the soundboard 2, greater acoustic sound and improved tone quality can be obtained since the pressure plate 22 is configured to cover and be strongly attached to both the piezoelectric element 20 and the lower panel 2b by means of glue. In consideration of the fact that the material of the pressure plate 22 has a great effect on the tone of sound, it is essential to form the pressure plate 22 with the same kind of well dried hard material as that of the soundboard 2.

The present invention is designed to transmit vibration generated from the strings 6 without loss. As illustrated in FIG. 4, as the tension of the strings 6 acts on the upper panel 2a, the resulting vibration is transmitted to the sound post 7 and consequently, is also transmitted to the piezoelectric element 20 that is embedded in the recess of the lower panel 2b of the soundboard 2 while being secured by the pressure plate 22. In this case, the pressure plate 22 functions to allow the vibration transmitted through the sound post 7 to be uniformly distributed throughout the piezoelectric element 20.

To play the stringed instrument of the violin group according to the present invention in an acoustic mode, vibration is generated from the strings 6 by friction between the strings and hairs of a bow. The vibration of the strings 6 is transmitted to the upper panel 2a by way of the bridge 18, causing the upper panel 2a to resonate. The resulting resonation of the upper panel 2a is transmitted to the lower panel 2b by way of the sound post 7 and the pressure plate 22. As such, air within the soundboard 2 is resonated upon receiving vibration energy of the upper and lower panels 2a and 2b. As the resonance of air is transmitted to the outside through the sound holes 8, audible sound is generated.

On the other hand, to play the stringed instrument of the violin group according to the present invention in an electric mode, the strings 6 are thrummed after a plug (not shown), which is connected to an amplifier or the like, has been inserted into the connection jack 26. Thereby, similar to the above description, vibration of the strings 6 is transmitted through the bridge 18, the upper panel 2a, the sound post 7, the pressure plate 22, the piezoelectric element 20 and the lower panel 2b in sequence. As the piezoelectric element 20 converts the transmitted vibration and pressure into electric signals and in turn, the electric signals are amplified by, e.g., the amplifier connected to the connection jack 26, amplified sound may be emitted from a speaker.

Accordingly, the single stringed instrument according to the present invention can serve not only to produce acoustic sound, but also to appropriately amplify original sound to the maximum extent possible. The present invention is applicable to all musical instruments of a violin group, such as a violin, a cello, a viola, a contrabass and the like.

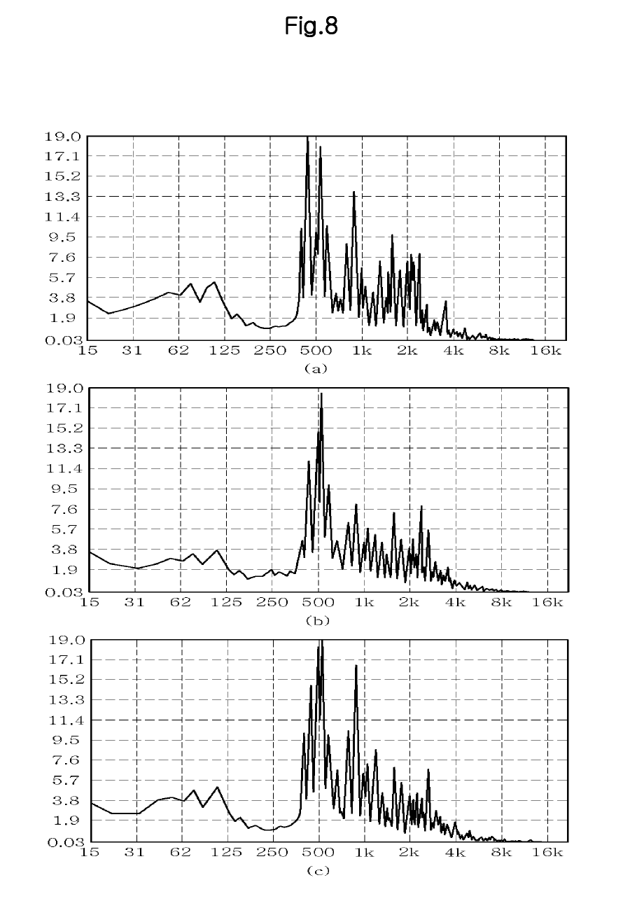

FIG. 8A illustrates a frequency band obtained by recording sound produced from an ordinary violin using a condenser microphone and analyzing the recorded sound using a computer. As shown, the highest frequency band is mainly obtained at about 500 Hz and about 1 kHz. FIG. 8B illustrates computational spectrum results of analyzing the frequency band and tone of sound that is produced from the stringed instrument according to the present invention and is recorded by the exterior condenser microphone under acoustic environments when no electricity is applied to the piezoelectric element and thus, no electric amplification of sound signals is performed. Similar to FIG. 8A, the highest frequency band is obtained at about 500 Hz and about 1 kHz and a similar spectrum is obtained. FIG. 8C illustrates spectrum results of analyzing the frequency band and tone of sound under an environment in which sound produced from the stringed instrument according to the present invention undergoes electric amplification using the piezoelectric element. Similar to FIGS. 8A and 8B, the sound has the highest frequency band at about 500 Hz and about 1 kHz.

In conclusion, the single stringed instrument according to the present invention has the effect of selectively generating general acoustic violin sound or electrically amplified sound without significant differences in the frequency and tone of sound.

As is apparent from the above description, according to the present invention, a piezoelectric element is embedded in a lower panel of a soundboard so as not to be seen from the outside and permits generation of the natural sound of a stringed instrument without use of an amplifier. Additionally, as a result of locating the piezoelectric element below a pressure plate used to support a sound post, tension of strings may be transmitted to the piezoelectric element, which allows the piezoelectric element to exhibit sufficient piezoelectric effects to achieve desired sound pressure and sound volume. The piezoelectric element is adapted to simultaneously receive vibration transmitted to both the lower panel of the soundboard and the sound post, thereby being capable of generating a high volume of sound (a wide frequency response). This may result in generation of sound similar to original sound of the stringed instrument to the maximum extent possible as well as efficient sound amplification.

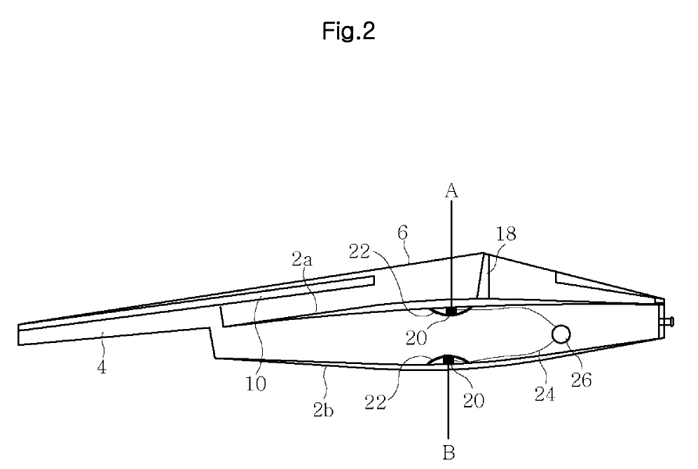

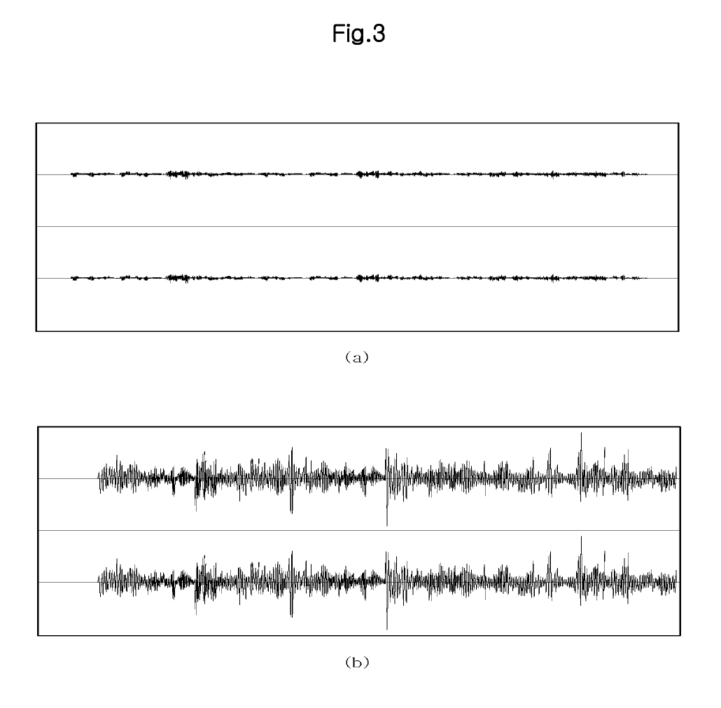

For example, if a piezoelectric element having the same size as that of the present invention is attached to a surface location A of the lower panel of the soundboard or a lower surface location B of the upper panel of the soundboard as illustrated in FIG. 2 rather than being installed to a location below the sound post where pressure is applied, sound having a maximum value of −20 dB within a range from the lower limit of −∞ to the upper limit of 0 dB is obtained. However, the piezoelectric element, which is embedded below the pressure plate according to the present invention, enables generation of sound having a maximum value of 2 dB (close to zero) as illustrated in FIG. 3B, which results in an enhancement in the intensity of sound up to about 10 times at maximum under the same conditions.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. An acoustic and electric combined stringed instrument of a violin group, comprising a soundboard including an upper panel and a lower panel arranged with an interval therebetween and a side panel surrounding the rims of the upper and lower panels, a neck part extending from the soundboard, the neck part being provided at a front surface thereof with a finger board and at a distal end thereof with a head, a string secured between a string reel on the head and a string fixture on a side end of the soundboard while being supported by a bridge,
wherein a piezoelectric element is provided in the lower panel, so as to convert vibration and pressure of the string into electric signals, and
wherein a sound post in the form of a support rod is installed between a lower surface of the upper panel and the piezoelectric element such that resonance generated from the upper panel is transmitted to the piezoelectric element and the lower panel through the sound post.

2. The stringed instrument according to claim 1,
wherein the piezoelectric element is embedded in a recess of the lower panel, and
wherein a pressure plate is interposed between the piezoelectric element and the sound post such that vibration transmitted through the sound post is uniformly distributed throughout the piezoelectric element via the pressure plate.

3. The stringed instrument according to claim 2, wherein the piezoelectric element has a rectangular shape and is oriented such that a long side thereof is perpendicular to the direction of wood grain and annular rings of the lower panel.

4. The stringed instrument according to claim 3, wherein the piezoelectric element has a length in a range from 20 to 30 mm and a width in a range from 8 to 14 mm, preferably, has a length in a range from 23 to 27 mm and a width in a range from 10 to 12 mm.

5. The stringed instrument according to claim 2, wherein the pressure plate is formed of the same material as that of the lower panel and is attached to have the same direction of wood grain as that of the lower panel.

6. The stringed instrument according to claim 2, wherein the piezoelectric element is secured in the recess by means of an adhesive.

7. The stringed instrument according to claim 6, wherein the piezoelectric element is prepared by attaching a cooper plate to an upper surface of a thin ceramic plate, attaching a PCB to a lower surface of the thin plate, and surrounding the resulting laminate with a copper tape, and a shield wire is connected to the PCB.

8. The stringed instrument according to claim 1, wherein a connection jack is provided at a location of the side panel of the soundboard and is electrically connected to the piezoelectric element to transmit electric signals from the piezoelectric element to an exterior amplifier speaker for sound amplification.

9. The stringed instrument according to claim 1, wherein the stringed instrument of the violin group includes any one of a violin, a cello, a viola and a contrabass.
